(19) United States
(12) Patent Application Publication
(10) Pub. No.: US 2010/0193608 A1
(43) Pub. Date: Aug. 5, 2010

(54) NOZZLE OF A GAS BURNER

(76) Inventor: JIN-CHIH LIOU, Taichung County (TW)

Correspondence Address: PHILLIP LIU, 6980, WHITEOAK DRIVE, RICHMOND, BC, V7E 4Z9, CA

(21) Appl. No.: 12/704,508

(22) Filed: Feb. 11, 2010

(30) Foreign Application Priority Data
Feb. 4, 2009 (TW) 098202704

(51) Int. Cl. F23D 14/48; B05B 7/06

(52) U.S. Cl. 239/429; 239/589

(57) ABSTRACT

A gas burner is provided with a nozzle. The nozzle includes a joint section, an annular rib, an eddy-producing device and an outlet section along an axis. The joint section includes a gas inlet channel defined therein along the axis. The outlet section extends from the joint section. The outlet section includes a wall made of adequate thickness and formed between an external side and an internal side along an axis in perpendicular to the axis. A gas/air mixture channel is defined in the wall along the axis. The eddy-producing device includes air inlet channels each extending throughout the wall not along a radius in perpendicular to the axis. The annular rib extends on the internal side of the outlet section and includes an aperture through which the gas inlet channel is in communication with the gas/air mixture channel.

### BACKGROUND OF INVENTION

1. Field of Invention

The present invention relates to a gas burner and, more particularly, to a nozzle of a gas burner for producing an eddy current of gas/air mixture to improve combustion of the gas/air mixture.

2. Related Prior Art

A gas-operated water heater or a tabletop cooking device includes at least one gas burner with at least one nozzle. Generally, such a nozzle provides gas/air mixture in a rectilinear manner. The rectilinear manner of the travel of the gas/air mixture entails problems. Firstly, a portion of the gas/air mixture is dissipated without combustion because it travels too fast and too far after leaving the nozzle. Secondly, undesirable red flames, which damage the gas burner faster than blue flames, are produced by combustion of the gas/air mixture because of inadequate time for mixing the gas with the air in the nozzle.

To overcome the foregoing problems, the applicant of the present application finished a nozzle and filed a Taiwanese patent application in 2001 and Taiwanese Patent No. 530920 was issued to the Taiwanese patent application in 2003. As disclosed in the Taiwanese patent, an additional helical element is inserted in an inlet channel defined in a nozzle. The helical element includes a helical channel. Gas and air are turned into an eddy current and mixed with each other when they are transferred through the helical element. The eddy current makes the gas/air mixture travel for a longer distance in the nozzle and improves the mixture of the gas with the air. Therefore, there are less red flames after the combustion of the gas/air mixture.

Gas burners equipped with nozzles and helical elements as disclosed in the Taiwanese patent are effective and efficient. The applicant of the present application is however not too proud to find a few problems with the nozzle equipped with the helical element. The equipment of the nozzle with the addition helical element inevitably increases cost and time for making and assembling parts.

Therefore, the present invention is intended to obviate or at least alleviate the problems encountered in prior art.

### SUMMARY OF INVENTION

It is the primary objective of the present invention to provide an inexpensive and effective nozzle for a gas burner.

To achieve the foregoing objective, the nozzle includes a joint section, an annular rib, an eddy-producing device and an outlet section along an axis. The joint section includes a gas inlet channel defined therein along the axis. The outlet section extends from the joint section. The outlet section includes a wall made of adequate thickness and formed between an external side and an internal side along an axis in perpendicular to the axis. A gas/air mixture channel is defined in the wall along the axis. The eddy-producing device includes air inlet channels each extending throughout the wall not along a radius in perpendicular to the axis. The annular rib extends on the internal side of the outlet section and includes an aperture through which the gas inlet channel is in communication with the gas/air mixture channel.

Other objectives, advantages and features of the present invention will become apparent from the following description referring to the attached drawings.

### BRIEF DESCRIPTION OF DRAWINGS

The present invention will be described via detailed illustration of two embodiments referring to the drawings where:

FIG. 1 is a cut-away view of a nozzle according to the first embodiment of the present invention;

FIG. 2 is a cross-sectional view of the nozzle shown in FIG. 1;

FIG. 3 is a perspective view of the nozzle shown in. FIG. 1;

FIG. 4 is a cross-sectional view of the nozzle taken along a line A-A shown in FIG. 2; and

FIG. 5 is a perspective view of a nozzle according to the second embodiment of the present invention.

### DETAILED DESCRIPTION OF EMBODIMENTS

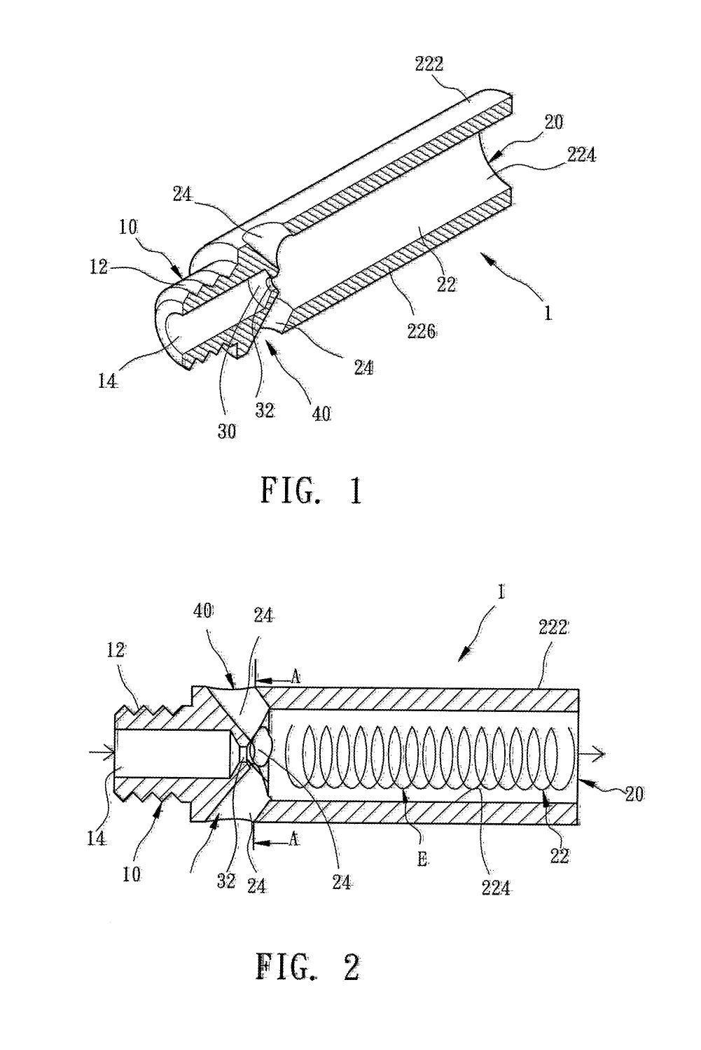

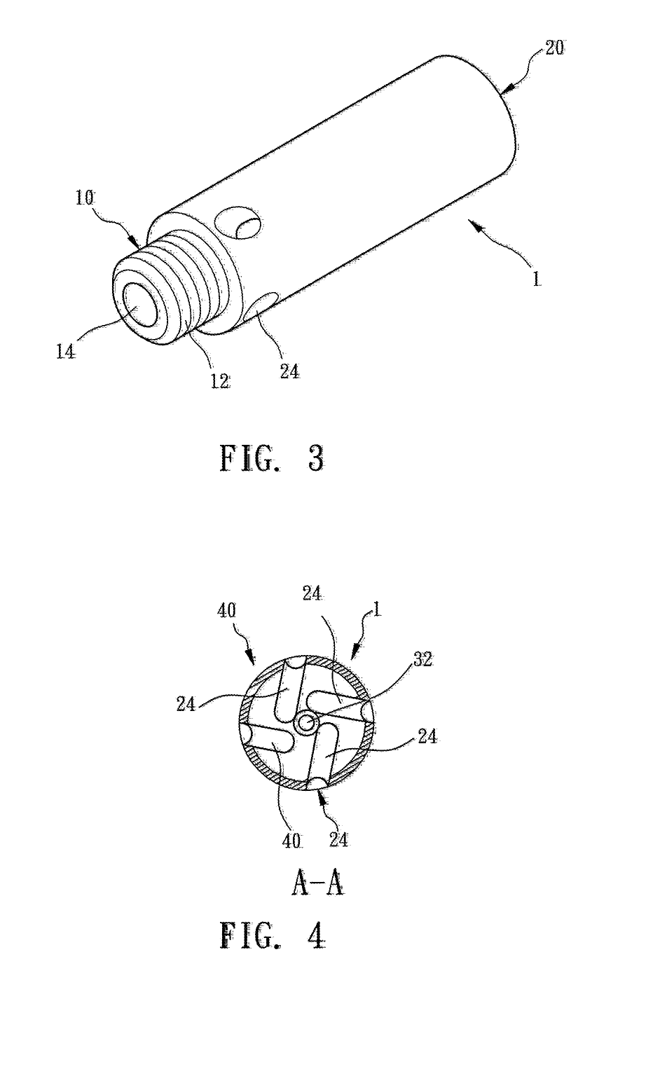

Referring to FIGS. 1 and 3, a nozzle 1 includes a joint section 10 and an outlet section 20 extended from the joint section 10 along an axis according to a first embodiment of the present invention. Obviously, the nozzle 1 is hollow throughout its length along the axis. A thread 12 is formed on an external side of the joint section 10. The thread 12 can be engaged with a thread formed on an internal side of a gas cock. A gas inlet channel 14 is defined in the joint section 10 along the axis. The outlet section 20 can be connected to a pipe of a gas burner.

The outlet section 20 includes a gas/air mixture channel 22 defined therein along the axis. Therefore, the outlet section 20 includes an external side 222 and an internal side 224 spaced from each other along a radius perpendicular to the axis. A wall 226 of the outlet section 20 is delimited by and between the external side 222 and the internal side 224. The wall 226 is made of proper thickness. An annular rib 30 is formed on the internal side 224, between the outlet section 20 and the joint section 10 along the axis. An aperture 32 is delimited by and in the annular rib 30. The diameter of the aperture 32 is smaller than that of the gas inlet channel 14 and that of the gas/air mixture channel 22.

Referring to FIGS. 2 and 4, air inlet channels 24 are defined in the outlet section 20. The air inlet channels 24 extend from the internal side 222 to the internal side 224. Air can be sucked into the gas/air mixture channel 22 from the exterior through the air inlet channels 24. Each of the air inlet channels 24 extends in parallel to a radius as shown in FIG. 4 and obliquely relative to the axis as shown in FIG. 2. Therefore, the air travels in a helical manner in the gas/air mixture channel 22, i.e., it travels clockwise or counterclockwise while traveling in a direction to the gas/air mixture section 20 from the joint section 10. Hence, the gas/air mixture is turned into an eddy current that improves the mixture of the gas with the air. Together, the air inlet channels 24 form an eddy-producing device 40.

Each of the air inlet channels 24 extends in parallel to a radius as shown; it can however extend obliquely relative to a radius in another embodiment. Each of the air inlet channels 24 extends obliquely relative to the axis as shown; it can however extend in a plane in perpendicular to the axis in another embodiment. There are four air inlet channels 24 as shown; the preferred number of air inlet channels 24 is however three.

In operation, the gas is transferred into the gas/air channel 20 from the gas inlet channel 14 through the aperture 32. The pressure of the gas is increased when the gas is transferred through the aperture 32. The air is sucked into the gas/air mixture channel 22 from the exterior through the air inlet channels 24 because of the increased pressure. The air travels in a helical manner and gets mixed with the gas in the gas/air mixture channel 22. Hence, the gas/air mixture is turned into the eddy current. The gas/air mixture is transferred to a gas burner from the nozzle 1 through the pipe. Finally, the gas/air mixture is burned at the gas burner.

The eddy current of the gas/air mixture travels for a long distance in the gas/air mixture channel 22, thus enabling the gas to get well mixed with the air. Therefore, the combustion of the gas/air mixture is complete, with few red flames produced. Moreover, the eddy current of the gas/air mixture reduces the axial speed at which it leaves the nozzle 1, thus avoiding dissipation of the gas/air mixture without combustion. Furthermore, the making of the air inlet channels 24 does not increase the cost of the nozzle 1, not like the provision of the additional helical element as discussed in the RELATED PRIOR ART.

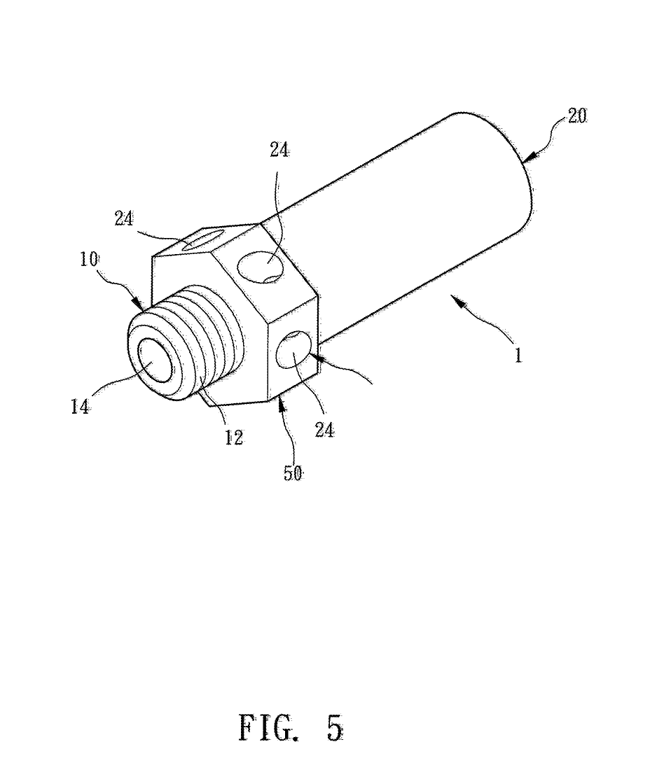

Referring to FIG. 5, there is shown a nozzle 1 according to a second embodiment of the present invention. The second embodiment is like the first embodiment except including a contact device 50 formed on the outlet section 20. The contact device 50 preferably includes an enlarged hexagonal collar as shown in FIG. 5. The hexagonal collar includes three pairs of parallel facets 52 for contact with two jaws of a wrench operable to spin the nozzle 1, thus facilitating the rotation of the nozzle 1. Accordingly, there are six air inlet channels 24 each extending to the internal side 224 of the outlet section 20 from a related one of the facets 52 of the hexagonal collar. The contact device 50 can however include only one pair of parallel facets 52 in another embodiment.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A nozzle extending along an axis and comprising:
a joint section (10) including a gas inlet channel (14) defined therein along the axis;
an outlet section (20) extending from the joint section (10) and comprising a wall (226) made of adequate thickness and formed between an external side (222) and an internal side (224) along an axis in perpendicular to the axis, a gas/air mixture channel (22) defined in the wall (226) along the axis, and air inlet channels (24) each extending throughout the wall (226) not along a radius in perpendicular to the axis;
an annular rib (30) extending on the internal side (224) of the outlet section (20) and comprising an aperture (32) through which the gas inlet channel (14) is in communication with the gas/air mixture channel (22).

2. The nozzle according to claim 1, wherein each of the air inlet channels (24) extends in parallel to a radius.

3. The nozzle according to claim 1, wherein each of the air inlet channels (24) extends obliquely relative to the axis.

4. The nozzle according to claim 1 further comprising a contact device (50) formed on the outlet section (20).

5. The nozzle according to claim 3, wherein the contact device (50) comprises a pair of parallel facets (52).

6. The nozzle according to claim 3, wherein the contact device (50) comprises a polygonal collar.
